(19) United States
(12) Patent Application Publication
(10) Pub. No.: US 2009/0121040 A1
(43) Pub. Date: May 14, 2009

(54) Liquid fertilizer, weed killer, and pesticide application device using exchangeable containers connected to an irrigation system

(76) Inventor: Theo Duncan, Auburn, CA (US)

Correspondence Address: Russ Weinzimmer, 614 Nashua Street, Suite 53, Milford, NH, 03055, US

(21) Appl. No.: 11/983,658

(22) Filed: Nov. 10, 2007

(51) Int. Cl. B05B 7/26

(52) U.S. Cl. 239/10; 239/310

(57) ABSTRACT

An apparatus and method are disclosed for introducing fertilizer, weed killer, pesticides, and other botanical treatment liquids into an irrigation system using an inexpensive, easily installed apparatus with exchangeable treatment containers. A water pipe adaptor connects in series with an irrigation pipe and supports a treatment container in an inverted, at least partly vertical orientation. Treatment liquid is drawn into the irrigation system by gravity and by Venturi effect suction. Embodiments include a replacement cap for sealing the adaptor, a barrier with a hole that controls the treatment dispensing rate, a constriction for increased suction, and/or a protrusion that breaks a membrane seal on a pre-filled container. In various embodiments, the container collapses or air and/or water displace the treatment liquid through venting holes. Embodiments with large containers include structural reinforcements or separate supporting stands. Some embodiments include a closable chamber that houses units and protects them from the weather.

### FIELD OF THE INVENTION

The invention generally relates to applying fertilizer, weed killer, pesticides and other liquid botanical treatments, and more specifically to apparatus and methods for applying such treatments through residential and commercial irrigation systems.

### BACKGROUND OF THE INVENTION

In many climates throughout the world, irrigation is required to enable lawns, shrubbery, trees, agricultural crops, and other plant life to survive and flourish. Small areas are typically irrigated by hand using a flexible hose or like means, while larger areas are often irrigated by a source of water supplied at an elevated pressure and distributed to the plant life through a system of rigid or semi-rigid pipes terminated by sprinklers, drip nozzles, and/or other outlets.

Irrigated areas typically range from very small patches of land to larger areas of landscaping surrounding homes, apartment complexes, schools, industrial parks, and golf courses. Even larger tracts of land are irrigated for agricultural purposes.

In addition to water, the application of fertilizer, weed killer, pesticides, and other treatment liquids is often desirable to further enhance the health and growth of plant life. These are often applied by specialized equipment that is costly and labor intensive, and can also lead to unwanted exposure of the user to fertilizer, weed killer, pesticide, and/or other treatment liquids. In some cases, each application of treatment liquid requires the services of gardener, crop duster, or other professional, further increasing the cost.

For small areas that are irrigated by hand using hoses, devices are well known that attach to the end of a hose and automatically mix fertilizer or another treatment liquid or solid with water flowing from the hose. Many of these devices use exchangeable treatment containers and/or containers that minimize or eliminate exposure of the user to the treatment materials. However, this approach involves significant manual labor and is not practical for larger land areas that are normally irrigated by a system of rigid or semi-rigid pipes terminated by sprinklers, drip nozzles, and/or other outlets.

Approaches are also known that use refillable tanks to contain treatment liquids and introduce them into rigid or semi-rigid pipes carrying irrigation water. However, these approaches are generally expensive and difficult to install, clean, and maintain. Also, the process of refilling them typically includes the risk of exposing the user to treatment chemicals. Finally, many of these approaches include complicated systems of valves and/or other actuators that further increase the cost, the likelihood of failure, and the difficulty of repair.

### SUMMARY OF THE INVENTION

An apparatus and method of use are disclosed for introducing botanical treatment liquid into an irrigation system. The apparatus includes a water pipe adaptor that can be connected in series with a water pipe in the irrigation system, and a treatment liquid input port that extends at an at least partly upward angle from the water pipe adaptor. The apparatus further includes an exchangeable treatment liquid container that can be connected to the treatment liquid input port so as to introduce treatment liquid into the irrigation system due to gravity and to Venturi effect suction generated by water flowing through the water pipe adaptor. In preferred embodiments, the apparatus is consumer friendly and inexpensive to connect to existing irrigation systems, such as residential irrigation systems, and is compatible with standard pipe sizes from one-half inch to six inches in diameter.

Preferred embodiments of the apparatus includes a replacement cap that can be connected by watertight means to the treatment liquid input port so as to seal the treatment liquid input port when a treatment liquid container is not connected thereto. In further preferred embodiments, the treatment liquid container connects to the treatment liquid input port by means of a threaded connection and a sealing washer and/or the treatment liquid container is made from plastic and/or is disposable. In still further preferred embodiments, the treatment liquid container is either collapsible or contains the treatment liquid in an inner collapsible bag or membrane, thereby allowing either the container itself (in the first instance) or the bag or membrane (in the second instance) to collapse as treatment liquid contained therein enters the irrigation system.

In some preferred embodiments where the treatment liquid container is pre-filled with liquid fertilizer, weed killer, pesticide, or another botanical treatment liquid, it is also sealed by a breakable membrane, and in some of these embodiments the treatment liquid input port includes a protrusion that breaks the membrane when the treatment liquid container is attached, thereby allowing the pre-filled liquid to flow into the water pipe adaptor. In some of these embodiments, the protrusion is part of a barrier inside of the treatment liquid input port, and there is a hole near the tip of the protrusion that allows treatment liquid to flow from the treatment liquid container through the hole and into the irrigation system at a desired rate.

In preferred embodiments, the treatment liquid input port of the water pipe adaptor includes a barrier that is penetrated by at least one treatment hole, so as to allow treatment liquid to flow from the treatment liquid container through the hole and into the irrigation system at a desired rate. In some of these embodiments the desired rate causes the entire volume of the treatment liquid container to enter the irrigation system in approximately 10 minutes. In other of these preferred embodiments the at least one treatment hole is located near the center of the barrier, where the Venturi effect suction is strongest, and at least one vent hole is located near the perimeter of the barrier, where the Venturi effect is weaker, so as to allow air and water from the irrigation system to flow into the treatment liquid container and displace treatment liquid as it flows into the irrigation system.

In some preferred embodiments where the pipe diameter, wall thickness, and material provide sufficient strength, the weight of the treatment liquid container is supported by its connection to the treatment liquid input port. In some of these preferred embodiments, the treatment liquid input port includes structural reinforcements that help it to support the weight of the treatment liquid container. These embodiments typically include pipes with diameters that range from one-half inch to three-quarters of an inch. In other preferred embodiments, the apparatus includes a supporting stand that rests on the ground, a slab, or some other structure, or is otherwise supported by something other than the treatment liquid input port.

In preferred embodiments, at least one apparatus of the invention is contained within a chamber that at least partly protects the at least one apparatus from the weather, and in some of these embodiments the chamber includes a closable lid and/or is located at least partly below grade.

In some preferred embodiments, the treatment liquid container has a capacity of 20 ounces or more, and/or the water pipe adaptor can be connected in series with a one-half inch water pipe, a three-quarters inch water pipe, a one inch water pipe, or another standard water pipe size up to six inches or more.

The method of the invention includes providing an apparatus as described above, including a treatment liquid container that is at least partly filled with treatment liquid, connecting the water pipe adaptor in series with a water pipe of the irrigation system, connecting the treatment liquid container to the treatment liquid container port, and operating the irrigation system, so as to cause treatment liquid to be combined with irrigation water and applied to plant life served by the irrigation system.

### BRIEF DESCRIPTION OF THE DRAWINGS

FIG. 1 is a side view of an embodiment that includes the basic elements of the apparatus;

FIG. 2 is a side view of an embodiment similar to FIG. 1, including structural reinforcements and a threaded connection between the treatment liquid container and the treatment liquid input port;

FIG. 3A is a side view of an embodiment similar to FIG. 2, except that the threaded connection has the opposite gender;

FIG. 3B is a side view of the embodiment of FIG. 3A, with the treatment liquid container removed and a replacement cap positioned in preparation for attachment to the treatment liquid input port;

FIG. 3C is a side view of the embodiment of FIG. 3B, with the replacement cap attached to the treatment liquid input port;

FIG. 4A is a side view of a barrier that includes a protrusion for breaking a membrane sealing a liquid treatment container, wherein the protrusion includes a treatment hole at the center, and the barrier includes vent holes near the perimeter;

FIG. 4B is a side view of a treatment liquid input port with the barrier of FIG. 4A installed;

FIG. 4C is a side view of a treatment liquid container that includes a collapsible treatment liquid compartment that collapses as liquid contained in the treatment liquid container flows into the irrigation system.

FIG. 5A is a side view of an embodiment similar to FIG. 2, except that the water pipe adaptor includes a constriction so as to increase the water flow rate and thereby increase the Venturi effect suction applied to the treatment liquid, and except that the structural reinforcements are larger and can support a heavier treatment liquid container;

FIG. 5B is a front view of FIG. 5A;

FIG. 5C is a side view of a replacement cap for the embodiment of FIG. 5A and FIG. 5B;

FIG. 5D is a top view of the replacement cap of FIG. 5C;

FIG. 5E is a side view of the embodiment of FIG. 5A and FIG. 5B with the treatment liquid container removed and the replacement cap of FIG. 5D and FIG. 5E installed;

FIG. 6A is a side view of an apparatus of the invention installed in series with a vertical pipe of a sprinkler irrigation system;

FIG. 6B is a side view of an apparatus of the invention installed in series with a horizontal pipe in a sprinkler irrigation system;

FIG. 6C is a side view of an apparatus of the invention installed in series with a horizontal pipe below grade in a sprinkler irrigation system, in an embodiment where the weight of the treatment container is supported by a stand resting on the ground;

FIG. 7A is a perspective view of an embodiment in which a chamber located primarily below ground and including a closable lid contains three instances of the apparatus of the invention, each of which includes a stand resting on the bottom of the chamber and supporting the weight of a treatment liquid container; and

FIG. 7B is a top view of the embodiment of FIG. 7A.

### DETAILED DESCRIPTION OF PREFERRED EMBODIMENTS

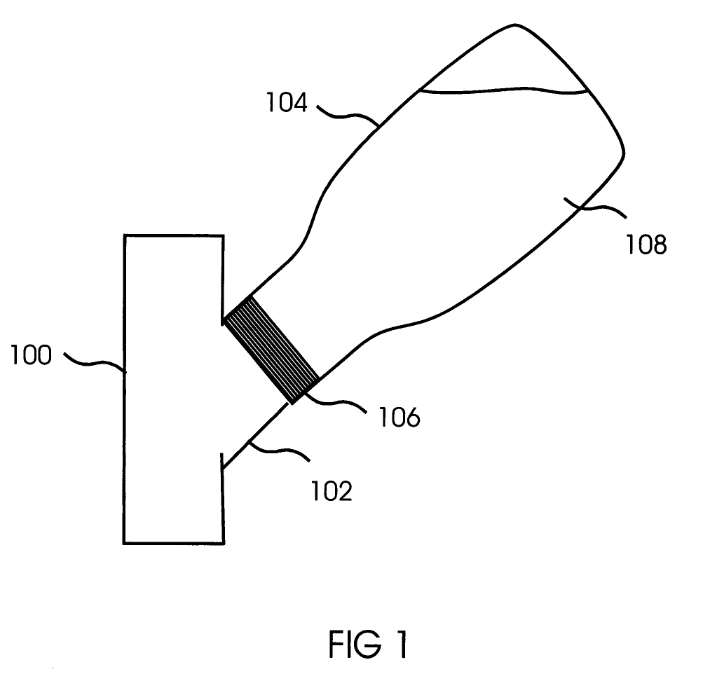

With reference to FIG. 1, the apparatus includes a water pipe adaptor 100 that can be glued, threaded, or otherwise connected in series with a water pipe in an irrigation system. A treatment liquid input port 102 extends at least partly upward from the water pipe adaptor, and an exchangeable treatment liquid container 104 can be attached to the treatment liquid input port 102 by a water tight connection 106, thereby supporting the treatment liquid container in an at least partly inverted orientation so that treatment liquid 108 contained in the treatment liquid container 104 drains toward the water pipe adaptor 100. Water flowing through the water pipe adaptor past the treatment liquid input port creates a low pressure suction according to the Venturi effect, thereby enhancing the tendency for liquid from the treatment liquid container to flow into the irrigation system.

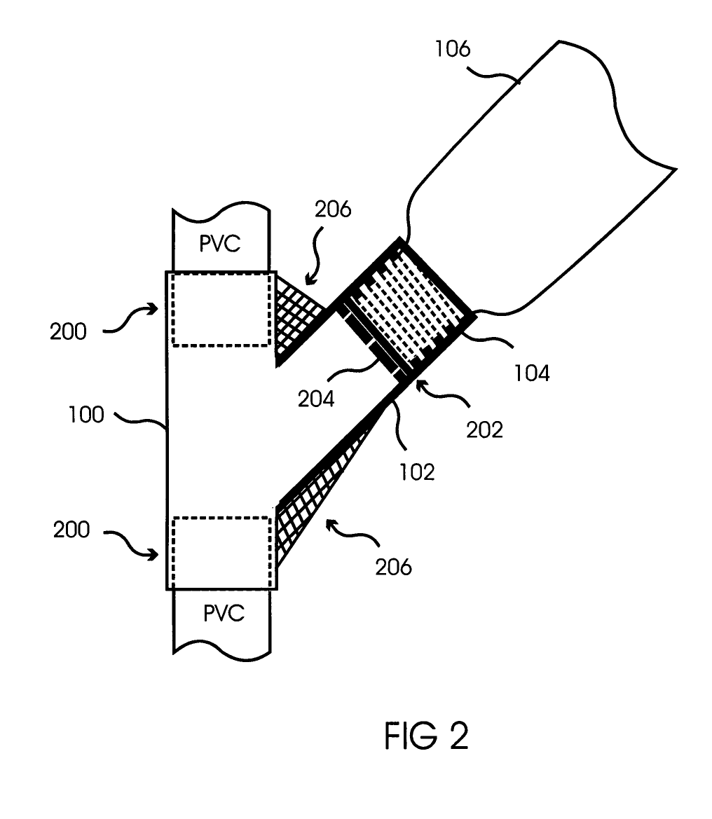

FIG. 2 illustrates a preferred embodiment of the invention where a section of a PVC water pipe has been removed and the ends of the remaining pipe have been inserted and glued into the ends 200 of the water pipe adaptor 100. The connection 104 between the treatment liquid input port 102 and the liquid treatment container 106 includes a female threaded section in the treatment liquid input port that is compatible with a male threaded section at the outlet of the treatment liquid container 106. A washer 202, similar to a standard garden hose washer, provides a water tight seal between the treatment liquid container 106 and the treatment liquid input port 102.

A disk-shaped barrier 204 partially blocks the flow of liquid into the treatment liquid input port. Treatment liquid flows into the treatment liquid input port 102 through a hole in the barrier 204 that is located near the center, where the Venturi effect suction is strongest. The hole is sized so as to allow the contents of the treatment liquid to flow from the treatment liquid container into the irrigation system at a desired rate, which in some preferred embodiments causes the entire contents of the treatment liquid container to enter the irrigation system in approximately 10 minutes. One or more additional holes are located near the perimeter of the barrier 204, where the Venturi effect is weaker, so as to allow water and/or air flowing through the irrigation system to enter the treatment liquid container and displace the treatment liquid.

The embodiment shown in FIG. 2 includes structural reinforcement 206 that enhances the ability of the treatment liquid input port to support the weight of a treatment liquid container.

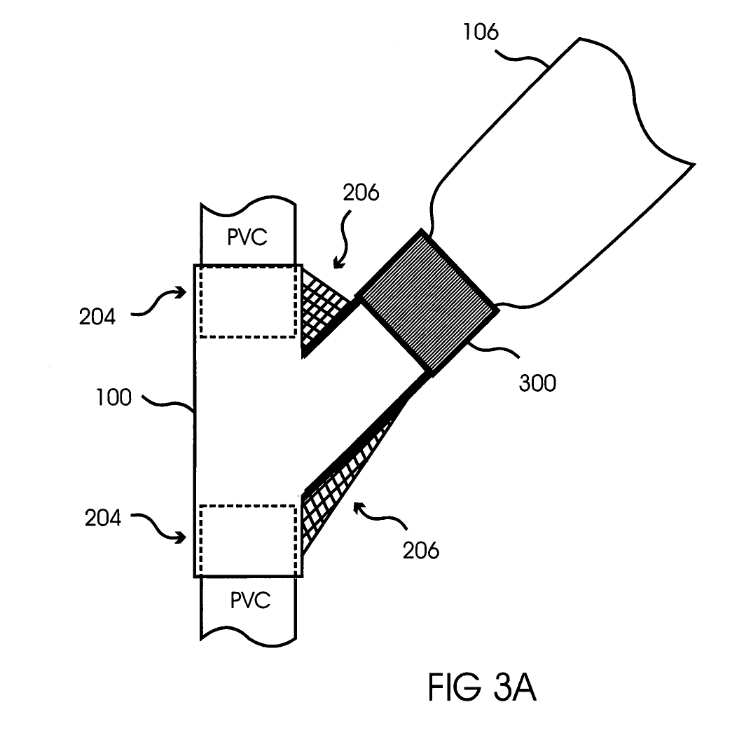

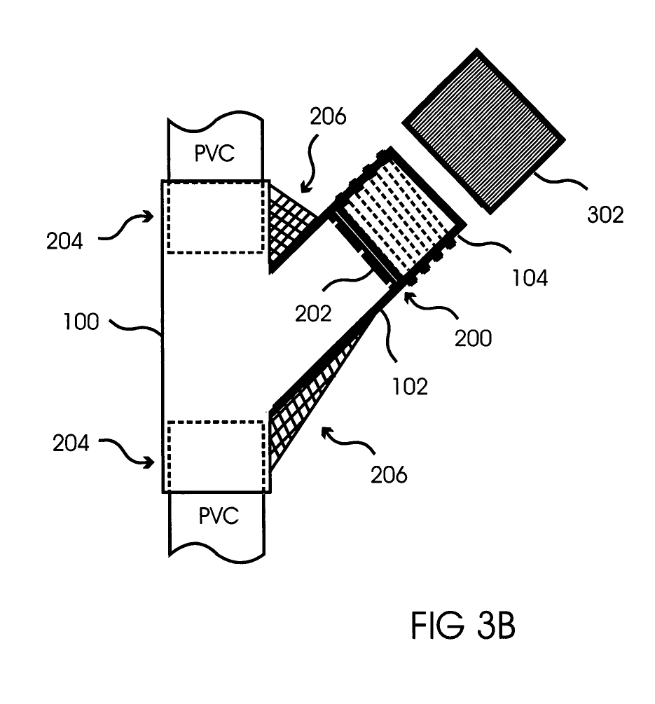

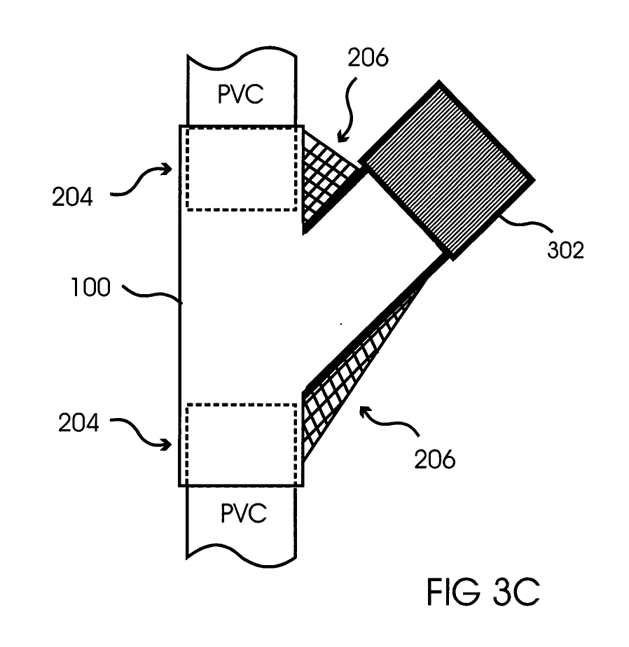

FIG. 3A illustrates a preferred embodiment that is similar to the embodiment of FIG. 2, except that the connection 300 between the treatment liquid input port and the treatment liquid container includes a male threaded section on the treatment liquid input port that is compatible with a female threaded section on the outlet of the treatment liquid container. FIG. 3B illustrates the same embodiment as FIG. 3A, in a configuration where the treatment liquid container has been removed and a replacement cap 302 is positioned to be attached to the treatment liquid input port in its place, so as to provide a water tight seal. FIG. 3C illustrates the embodiment of FIG. 3B with the replacement cap installed.

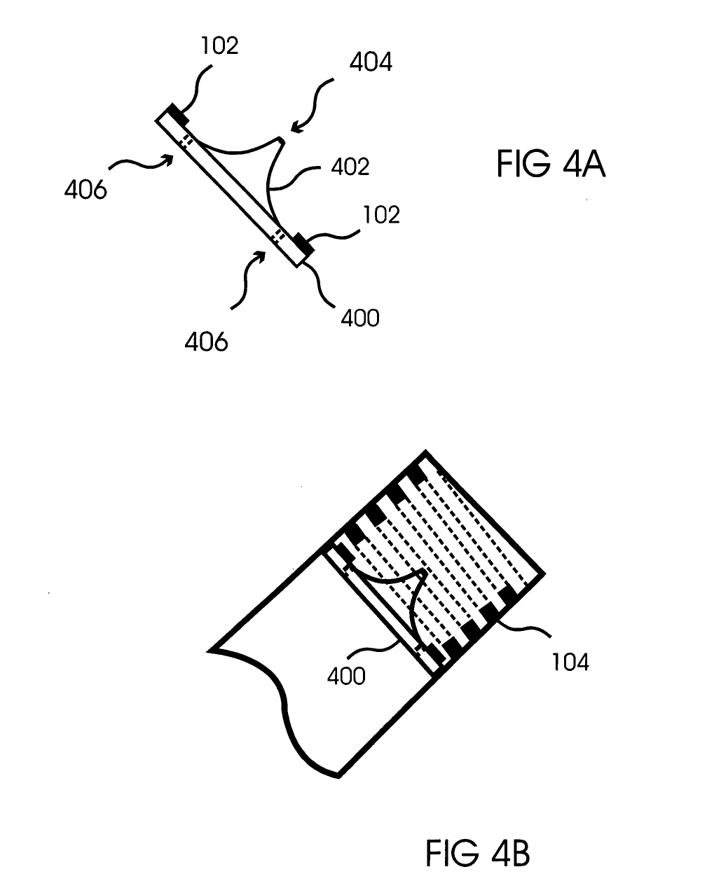

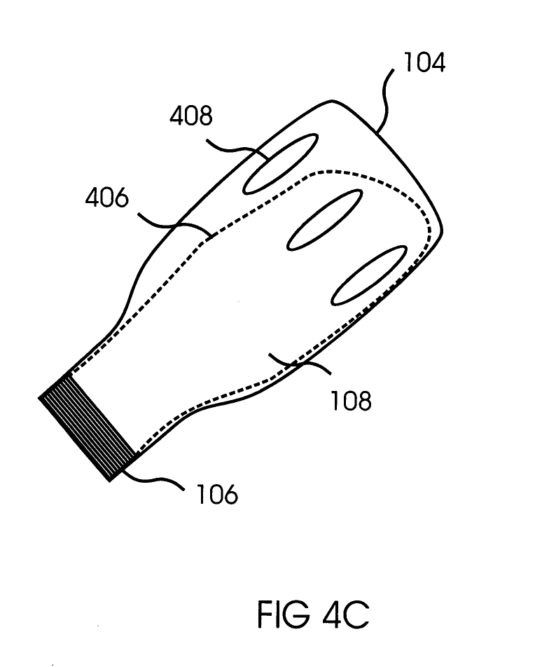

As mentioned with regard to FIG. 2, some preferred embodiments include a barrier 204 that partially blocks the flow of liquid into the treatment liquid input port. A hole near the center of the barrier allows treatment liquid to flow into the irrigation system at a desired rate. With reference to FIG. 4A, in some of these preferred embodiments the barrier 400 includes a protrusion 402 that is shaped and sized so as to break a membrane that seals the outlet of a pre-filled treatment liquid container. In FIG. 4A, a hole 404 in the center of the protrusion 402 allows liquid from the treatment liquid container to flow into the treatment liquid input port at a desired rate. Additional holes 406 located near the perimeter of the barrier 400, where there is less Venturi effect suction, allow water and/or air flowing through the irrigation system to enter the treatment liquid container and displace the volume vacated by treatment liquid flowing into the irrigation system.

FIG. 4B shows the barrier 400 of FIG. 4A installed in the connecting section 104 of a treatment liquid input port.

Some preferred embodiments do not include the additional holes 406 shown in FIG. 4A, but instead provide a treatment liquid container that is collapsible. In still other preferred embodiments, the treatment liquid is held within a collapsible bag or membrane located inside of a ventilated bottle or other supporting container. FIG. 4C illustrates a preferred embodiment in which treatment liquid 108 is contained within a collapsible bag 406 that is physically supported by a rigid or semi-rigid container 104 that includes ventilation holes 408 so as to allow air to fill the container 104 as the treatment liquid 108 enters the irrigation system and the bag 406 collapses.

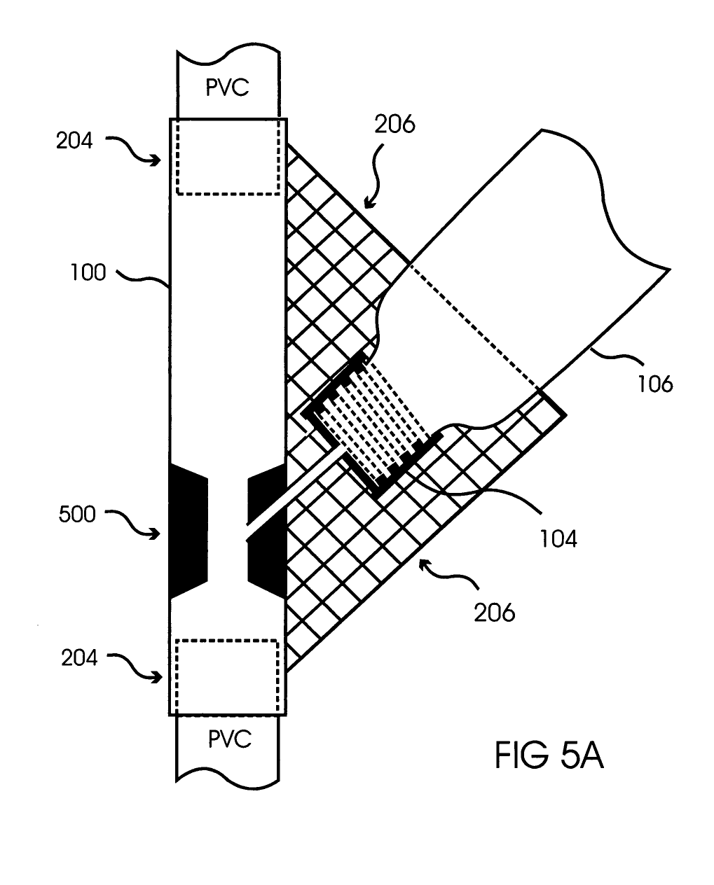

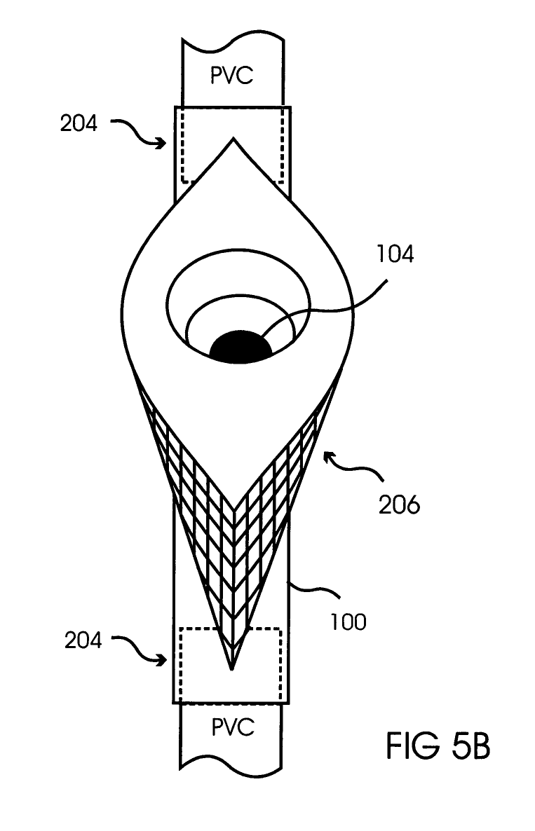

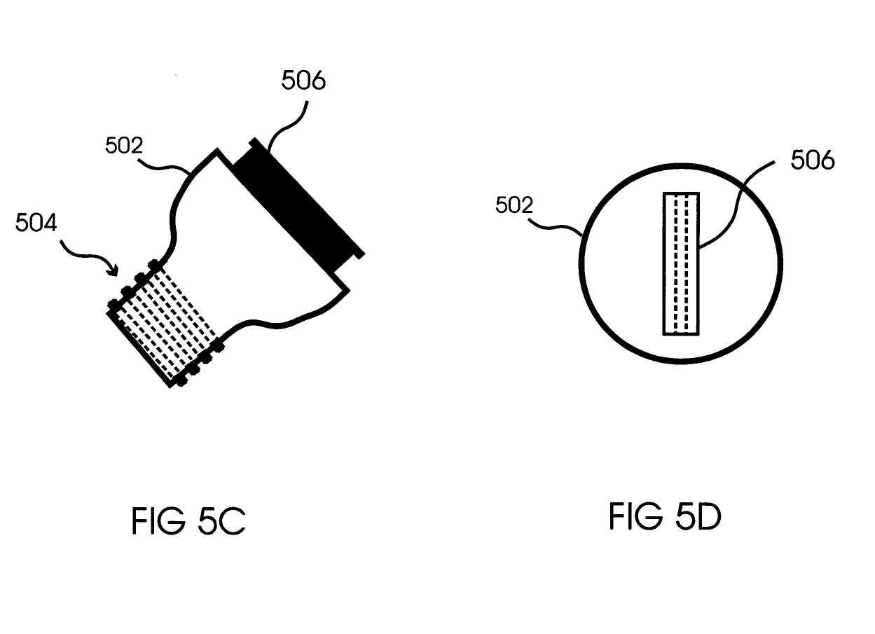

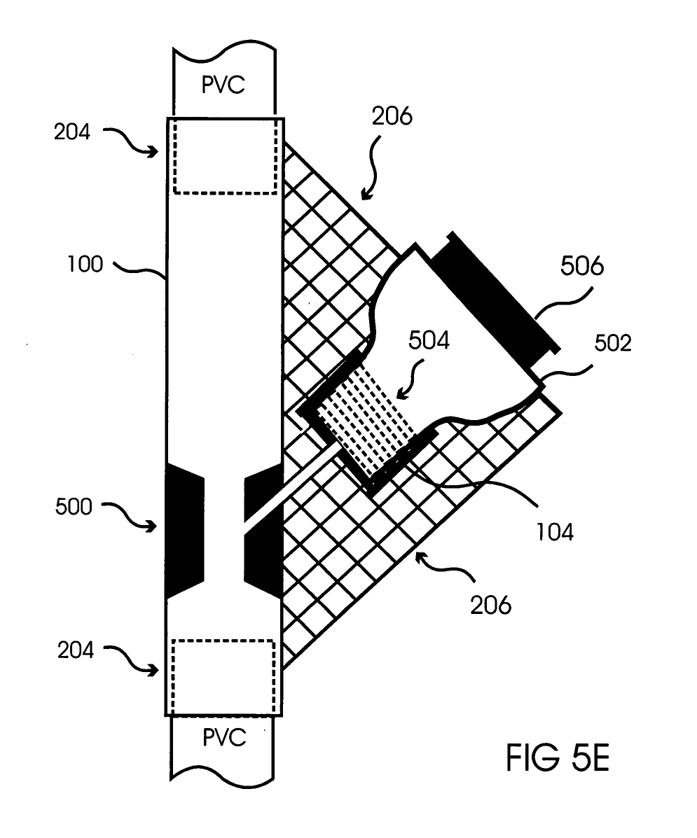

FIG. 5A illustrates a preferred embodiment similar to the embodiment of FIG. 2, except that the structural reinforcement 206 is larger and surrounds the lower portion of the treatment liquid container 106. In addition, the water pipe adaptor 100 includes a constricted section 500 with a reduced inner diameter that causes water to flow more rapidly and thereby further increases the Venturi effect suction. FIG. 5B shows the same embodiment from the front.

FIG. 5C illustrates a replacement cap that is compatible with the embodiment of FIG. 5A and FIG. 5B. The cap 502 includes a connecting section 504 with male threads that is compatible with the connecting threads 104 of the treatment liquid input port 102. The sides of the replacement cap 502 approximate the sides of the treatment liquid container near its threaded outlet, and the top of the cap includes a handle 506 to facilitate grasping the replacement cap and rotating it so as to engage and disengage it with the treatment liquid input port. FIG. 5D shows a top view of the replacement cap of FIG. 5C.

FIG. 5E illustrates the embodiment of FIG. 5A and FIG. 5B, with the replacement cap of FIG. 5C and FIG. 5D installed.

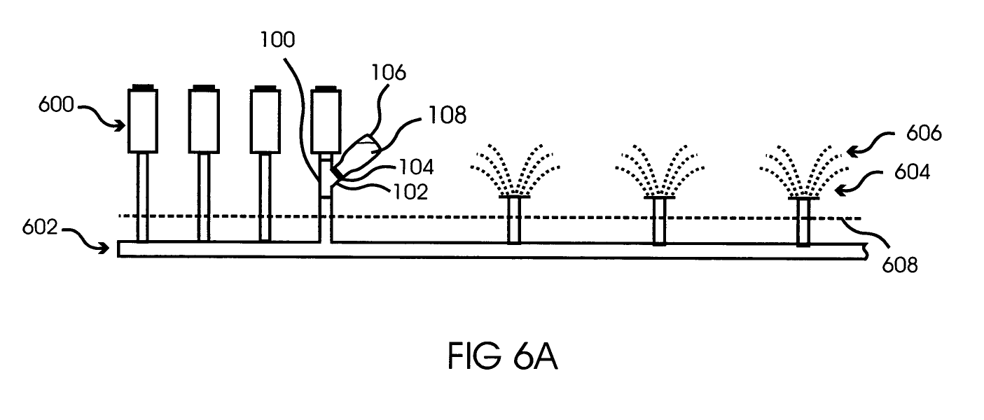

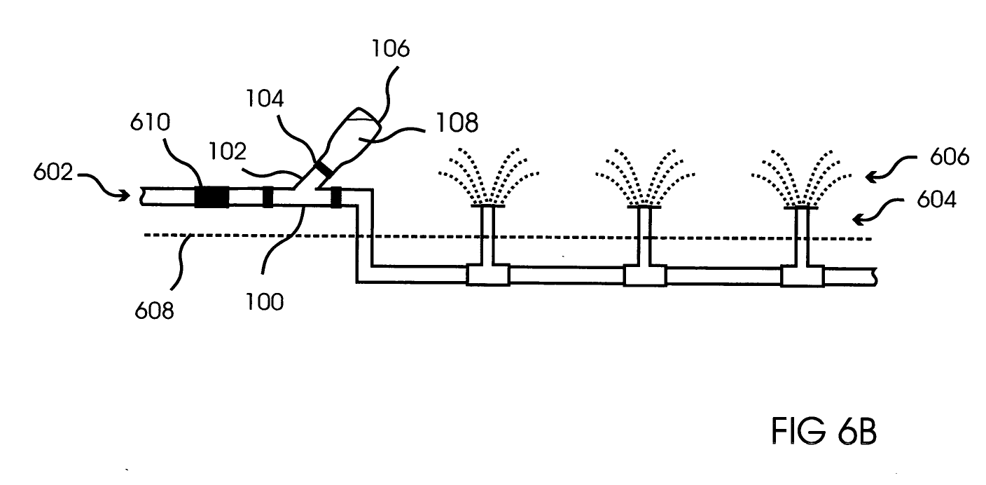

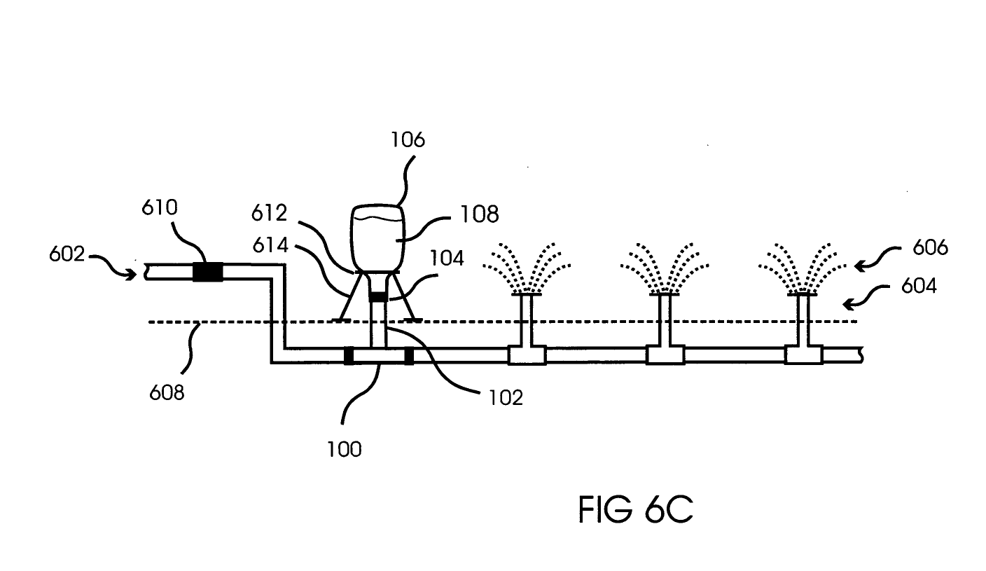

FIG. 6A illustrates the embodiment of FIG. 1 attached to an in-ground sprinkler system. The sprinkler system includes a plurality of controlling check valves 600 that supply water to a series of pipes 602 delivering water to sprinkler heads 604 throughout the area to be irrigated, thereby delivering a shower of water 606 from each sprinkler head that approximates the effects of natural rainfall. The pipes 602 are located below grade 608, so as to minimize the visibility of the irrigation system and also reduce tripping and other hazards. The water pipe adaptor 100 of the invention is connected above grade in series with a water pipe that flows from a check valve 600 vertically downward to a below grade pipe 602, and is oriented so as to support an exchangeable treatment liquid container inverted at an angle of approximately 45 degrees.

FIG. 6B illustrates the same embodiment attached to a horizontal section of water pipe of a similar sprinkler system. In this sprinkler system, the check valves 610 are separate from the control valves (not shown). FIG. 6C illustrates a preferred embodiment that is able to support treatment liquid containers that are too heavy to be supported by a treatment liquid input port, even with structural reinforcements. In this embodiment, the treatment liquid container is supported by a stand 612 resting on legs 614 that extend to the ground 608. The treatment liquid input port 102 extends vertically at right angles to the water pipe adaptor 100, which is connected in series to a horizontal section of pipe located below grade.

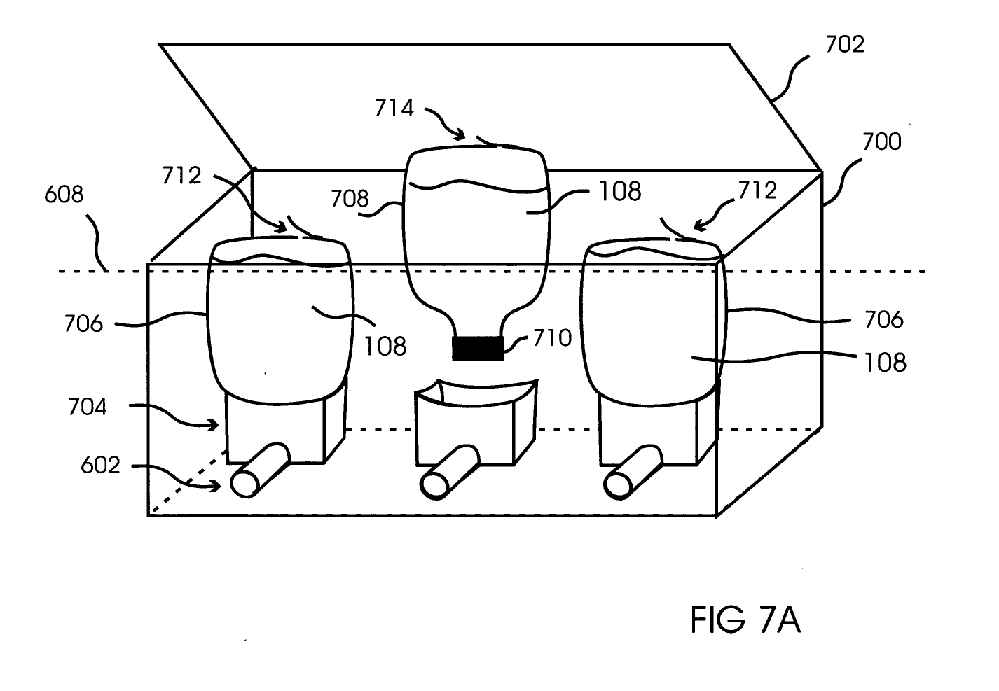

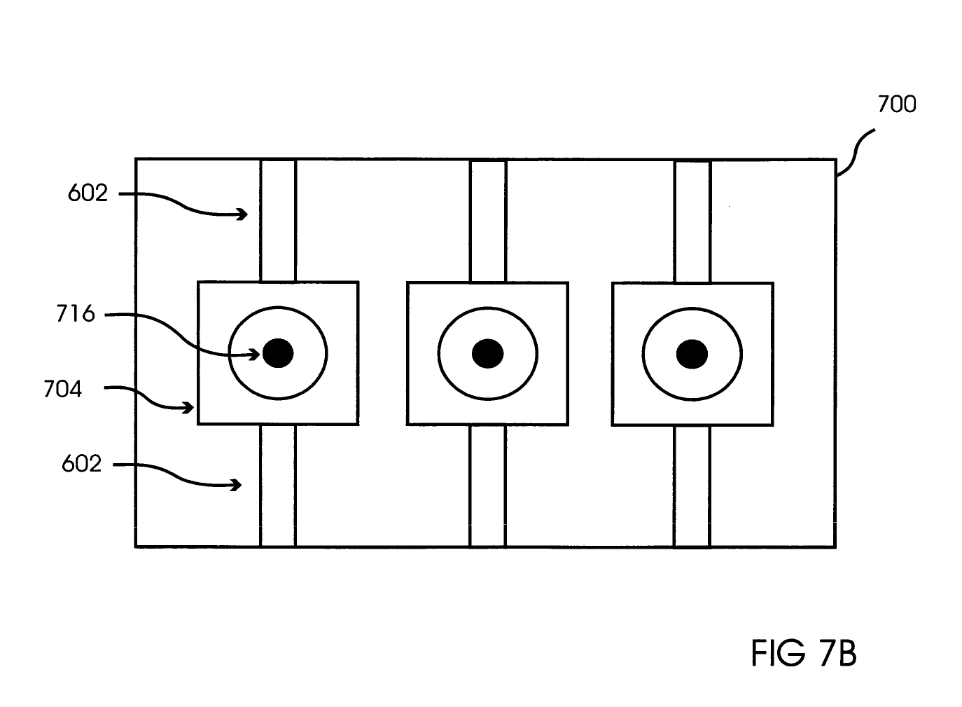

FIG. 7A illustrates a preferred embodiment that includes a chamber 700 for housing one or more instances of the invention and protecting them from the weather. In the embodiment of FIG. 7A, the chamber is located below grade 608, except for the uppermost part and the covering lid 702. In similar embodiments, it is located either above grade or only partly below grade. The chamber 700 includes one or more docking modules 704, each of which rests on the bottom of the chamber and is able to support the weight of a treatment liquid container 706, 708 and each of which includes a connecting section similar to the connecting section of FIG. 2 or FIG. 3B (not shown in FIG. 7A), connectable to the outlet of a treatment liquid container 706, 708. In this embodiment, vent holes 712, 714 are included in the bottoms of the treatment liquid containers (i.e. near the parts of the containers that are uppermost when the containers are inverted and in use) that allow air to enter the containers and displace the treatment liquid as it enters the irrigation system. Venturi effect suction ensures that a negative pressure is applied to the treatment liquid container when the irrigation water is flowing, and gravity ensures that no treatment liquid escapes through the vent holes when the irrigation water is not flowing.

In the embodiment of FIG. 7A, the vent holes 712, 714 are sealed until use by sealing flaps glued over the vent holes. The flaps can be easily removed by pulling on one end of each flap that is left unglued and thereby easily graspable. In FIG. 7A, the flaps are shown partly removed 712 on two of the treatment liquid containers 706, and not yet removed 714 on the third treatment liquid container 708. Similar vent holes and sealing flaps are used in other preferred embodiments over the full range of treatment liquid container sizes.

In FIG. 7A, one of the treatment liquid containers 708 is shown positioned in preparation for connecting to its docking module 702, so as to more fully show the shape of the treatment liquid container and the threaded connecting section 710 at its outlet.

FIG. 7B is a top view of the embodiment of FIG. 7A, where the covering lid 702 has been omitted for visual clarity. The connecting sections 716 of the treatment liquid input ports can be seen in the central parts of the docking modules 704. When a treatment liquid container 708 is not installed, a replacement cap similar to the cap shown in FIG. 3B 302 is used to seal the connecting section 716 of a treatment liquid input port.

Other modifications and implementations will occur to those skilled in the art without departing from the spirit and the scope of the invention as claimed. Accordingly, the above description is not intended to limit the invention except as indicated in the following claims.

What is claimed is:

1. An apparatus for introducing botanical treatment liquid into an irrigation system that is easy to use and low in cost, the apparatus comprising:
a water pipe adaptor, connectable in series with a water pipe in the irrigation system;
a treatment liquid input port, extending at least partly upward from the water pipe adaptor when the water pipe adaptor is connected in series with the water pipe in the irrigation system; and
an exchangeable treatment liquid container, connectable by watertight means to the treatment liquid input port so as to cause liquid located in the treatment liquid container to drain toward the water pipe adaptor.

2. The apparatus of claim 1, further comprising a replacement cap, connectable by watertight means to the treatment liquid input port so as to seal the treatment liquid input port when a treatment liquid container is not connected thereto.

3. The apparatus of claim 1, wherein the treatment liquid container is connectable to the treatment liquid input port by means of a threaded connection and a sealing washer.

4. The apparatus of claim 1, wherein the treatment liquid container is pre-filled with a liquid that is one of a fertilizer, a weed killer, a pesticide, and other botanical treatment liquids.

5. The apparatus of claim 5, wherein the treatment liquid container is sealed by a breakable membrane, and wherein the treatment liquid input port of the water pipe adaptor includes a protrusion that breaks the breakable membrane when the treatment liquid container is attached to the treatment liquid input port, thereby allowing the pre-filled liquid to flow into the water pipe adaptor.

6. The apparatus of claim 5, wherein the protrusion is part of a barrier inside of the treatment liquid input port, and wherein a hole penetrates the barrier near the tip of the protrusion, thereby allowing treatment liquid to flow from the treatment liquid container through the hole and into the irrigation system at a desired rate.

7. The apparatus of claim 1, wherein the treatment liquid container includes a collapsible treatment liquid compartment that collapses as liquid contained in the treatment liquid container flows into the irrigation system.

8. The apparatus of claim 1, wherein the treatment liquid container includes an air vent hole located near the region of the container that is uppermost when the container is in use, and wherein the air vent hole is sealed by a removable seal that can be removed to allow air to enter the container and displace treatment liquid as the treatment liquid enters the irrigation system.

9. The apparatus of claim 1, wherein the treatment liquid input port includes a barrier that is penetrated by at least one treatment hole, so as to allow treatment liquid to flow from the treatment liquid container through the hole and into the irrigation system at a desired rate.

10. The apparatus of claim 9, wherein the desired rate causes the entire volume of the treatment liquid container to enter the irrigation system in approximately 10 minutes.

11. The apparatus of claim 9, wherein the at least one treatment hole is located near the center of the barrier, and wherein the barrier is also penetrated by at least one vent hole located near the perimeter of the barrier, so as to allow air and water from the irrigation system to flow into the treatment liquid container and displace treatment liquid as it flows into the irrigation system.

12. The apparatus of claim 1, wherein the treatment liquid container is disposable.

13. The apparatus of claim 1, wherein the treatment liquid container is physically supported by its connection to the treatment liquid input port.

14. The apparatus of claim 13, further comprising structural reinforcements that enhance the ability of the treatment liquid input port to support the weight of the treatment liquid container.

15. The apparatus of claim 1, further comprising a supporting stand that at least partly supports the weight of the treatment liquid container, wherein the stand is supported by at least one of the ground, a concrete slab, and other supporting surfaces and structures other than the treatment liquid input port.

16. The apparatus of claim 1, further comprising a chamber that contains at least one apparatus of the invention and at least partly protects the at least one apparatus from exposure to the weather.

17. The apparatus of claim 12, wherein the chamber includes a closable cover.

18. The apparatus of claim 12, wherein the chamber is located at least partly below grade.

19. The apparatus of claim 1, wherein the water pipe adaptor is connectable in series by watertight means with at least one of:
a one-half inch water pipe;
a three-quarters inch water pipe;
a one inch water pipe;
a one and one quarter inch water pipe;
a one and one half inch water pipe;
a two inch water pipe;
a two and one half inch water pipe;
a three inch water pipe;
a four inch water pipe;
a five inch water pipe;
a six inch water pipe;
and other standard irrigation water pipe sizes.

20. A method for applying treatment liquid to a region served by an irrigation system, the method comprising:
providing a water pipe adaptor, connectable in series with a water pipe in the irrigation system and including a treatment liquid input port extending at least partly upward from the water pipe adaptor when the water pipe adaptor is connected in series with the water pipe in the irrigation system;
providing a treatment liquid container, at least partly filled with treatment liquid, connectable by watertight means to the treatment liquid input port so as to cause liquid in the treatment liquid container to drain toward the water pipe adaptor;
connecting the water pipe adaptor in series with the water pipe in the irrigation system;
connecting the treatment liquid container to the treatment liquid container port on the water pipe adaptor; and
operating the irrigation system, so as to cause treatment liquid contained in the treatment liquid container to be combined with irrigation water and applied to plant life served by the irrigation system.
